(19) United States
(12) Patent Application Publication
(10) Pub. No.: US 2015/0083048 A1
(43) Pub. Date: Mar. 26, 2015

(54) Feeder for Animals

(71) Applicant: CRYSTAL SPRING COLONY FARMS LTD., Ste. Agathe (CA)

(72) Inventor: Peter Francis McAdams, Ste. Agathe (CA)

(21) Appl. No.: 14/036,791

(22) Filed: Sep. 25, 2013

(51) Int. Cl. A01K 7/06; A01K 5/02

(52) U.S. Cl. CPC A01K 7/06; A01K 5/0225
USPC 119/51.5

(57) ABSTRACT

A feeder for feeding animals at the weanling stage has a trough with two opposed outwardly inclined front walls over which the animals can reach for taking feed from the trough and a feed hopper for discharging feed downwardly onto a shelf above the trough. Water is supplied into the trough through a water line with a series of animal actuated nipples so that the animals may take the feed dry on the shelf or wet from the trough. The water line in order to restrict flow rate to the nipples includes a flexible restriction hose located within the water fine through which the water passes with the hose having a coupling at one end holding the hose at a fixed position within the pipe and causing the water in the pipe to pass through the hose to the opposed end which is free in the water line prior to reaching the nipples.

This invention relates to a feeder for animals, of the type for feeding dry feed in particulate form, which includes a substantially horizontal surface beneath a hopper so that the feed from the hopper is discharged onto the surface from which the feed can be transferred by the animal to a trough for mixing with water.

### BACKGROUND OF THE INVENTION

An example of a feeder of this type is shown in U.S. Pat. No. 4,660,508 (Kleinsasser) and this type of feeder has become very successful and is widely known as a wet/dry feeder in view of the fact that the animal can take dry feed from the shelf of the feeder or can apply water into feed discharged into the trough to take the feed in the trough in wet condition.

The intention is that the animals themselves control the amount of water supply by providing nipples in the trough which can be actuated by the animal to discharge water into the trough to mix with the feed. One advantage of this type of feeder is that the animals can mix the feed to the consistency they prefer so that they are encouraged to eat as much as possible by ensuring that they are not discouraged from eating by the feed being too dry or too wet. It has been found that this type of feeder has considerable increase in weight gain for the animals over conventional dry feeders.

Feeders of this type can either be double sided that is the feeder has two sides each of which can be accessed by a different set of animals so that generally the feeder is placed in a fence line to supply feed to animals in two separate panic. Other type of feeders are however single sided so that they have generally a vertical rear wall with the trough presented forwardly of that rear wall and the animals accessing the feeder only from the trough side of the rear wall.

In U.S. Pat. No. 5,640,926 of the present inventor issued Jun. 24, 1997 is disclosed a feeder of the above type. In this feeder, the height of the shelf from the trough is adjustable so as to accommodate a change in size of the animals from a smaller size up to a larger size as the animals grow.

In U.S. Pat. No. 5,967,083 (Kleinsasser) issued Oct. 19, 1999 is disclosed a feeder of the above type. In this feeder, the height of the side wall of the trough from the base of the trough is adjustable so as to accommodate a change in size of the animals from a smaller size up to a larger size as the animals grow.

Feeders of this type are designed and manufactured for hogs from weanlings up to finishers and the above adjustable types can be used in some circumstances to accommodate growth or different feeders of fixed dimensions for different sizes of animal may be provided.

One problem which has existed since the invention of this type of feeder is that very young weanlings have a tendency to play with or activate the water nipples due to their recent suckling and hence they release too much water into the trough so that the feeder becomes overwhelmed with consequent blocking of the feed supply to the shelf. Of course the presence of the excess water also inhibits the feed intake of the animals. It has been noted that after a few days or weeks the animals lose this tendency and manage the water supply by activating the nipples only when they require as do older animals. However the difficulties during the first days or weeks have dramatically reduced the acceptability of the feeder for weanlings despite its known feed uptake advantages. Many operators will therefore not use this type of feeder for weanlings due to the repeated attention and maintenance which is required during this initial stage.

Many attempts have been made to overcome this problem by various techniques including controlling the pressure of the water supply to the nipples so that the amount dispensed is reduced.

In U.S. Pat. No. 7,832,356 (Kleinsasser) issued Nov. 16, 2010 is disclosed an arrangement of this type in which water is normally supplied through a first water supply line which has a series of nipples controlled by the animals. However, while the weanlings are very young the first water supply line is closed off and water is supplied from a second supply line which is managed by a timer.

In U.S. Pat. No. 5,255,632 (Thomas) issued Oct. 26, 1992 is disclosed an arrangement of this type in which the animals are free to operate as the nipples at their own volition but an additional sensor is provided in the trough which acts to control a valve in the supply line to prevent the water level exceeding a predetermined maximum.

Up to now all of these attempts have been either completely unsuccessful or less than optimum and a significantly reduced percentage of feeders of this type are used for weanlings. Only those operators who are willing to accept the repeated maintenance to remove excess water and to clean the resulting mess and blockage problems are able to use this type successfully.

### SUMMARY OF THE INVENTION

It is one object of the present invention to provide an improved feeder for animals of this general type which prevents the animals from introducing excess water levels within the trough while allowing free access to the water dispensing nipples.

According to a first aspect of the invention there is provided method of feeding animals comprising:

providing for the animals access to a feeder;

providing in the feeder an elongate trough having a base and a sidewall for receiving and containing feed and water and arranged such that the head of the animal can reach over an upper front edge of the sidewall to the base for eating the feed and water;

providing in the feeder an elongate shelf providing a substantially horizontal surface for receiving feed;

the horizontal surface of said shelf being arranged at a height above and rearwardly of said front edge so as to allow access by the head of the animal to said shelf for direct feeding therefrom, and between said shelf and said front edge to the base;

providing in the feeder a hopper for continually depositing feed onto said shelf arranged such that deposited feed on the shelf remains on said shelf but can be removed to the trough by the animal;

providing a water supply for the feeder for dispensing water into the trough including a pipe supplying water to the feeder;

and managing the water supply to the trough by:
providing at least one nipple in the feeder actuable by the animals for control by the animals of the dispensing of the water into the trough arranged such that said at least one nipple avoids dispensing water onto the shelf;
and reducing a flow rate of water through the pipe by providing in the water supply a hose through which the water passes prior to reaching said at least one nipple where the hose has a diameter less than the pipe and less than 0.5 inches.

Preferably to provide a required restriction to the flow rate the hose has a diameter less than 0.25 inch and more preferably of the order of 5/32 inch.

Preferably the hose is a simple flexible plastics hose which can be inserted into the rigid metal pipe for protection and floats within the pipe. However the pipe can form a rigid portion which is connected into the pipe as a portion of the length of the pipe.

Preferably the hose is located within the pipe and is attached at one end to a coupling arranged to be located within the pipe to hold the coupling at fixed position within the pipe and to cause all water in the pipe to pass through the hose.

Preferably an opposed end of the hose is free to float within the pipe. However it may also be anchored by another coupling.

Preferably the coupling is conveniently located at an end connector of a first pipe portion of the pipe where the first pipe portion is connected to a second pipe portion. This can be conveniently located at the connector between a water line portion within the feeder and a supply line portion extending vertically from the feeder to an overhead supply, so that the pipe portion containing the hose forms the water line located in the trough to which the nipples are connected.

Preferably the coupling of the hose is attached to the hose as a press fit and the coupling of the hose includes a collar which has an outside edge engaging an inner surface of the pipe to hold the coupling at a fixed position within the pipe.

Preferably the water supply line is arranged beneath the shelf and arranged to direct water downwardly from the nipples into the trough, with the nipples arranged such that the animal is not intended to drink directly from it.

Preferably there is provided a row of nipples along a water line of the pipe within the feeder so as to discharge water from the hose into the trough.

According to a further aspect of the invention there is provided a feeder for animals comprising:

an elongate trough having a base and a sidewall for receiving and containing feed and water and arranged such that the head of the animal can reach over an upper front edge of the sidewall to the base for eating the feed and water;

an elongate shelf providing a substantially horizontal surface for receiving feed;

the horizontal surface of said shelf being arranged at a height above and rearwardly of said front edge so as to allow access by the head of the animal to said shelf for direct feeding therefrom, and between said shelf and said front edge to the base;

a hopper for continually depositing feed onto said shelf arranged such that deposited feed on the shelf remains on said shelf but can be removed to the trough by the animal;

a water supply for the feeder for dispensing water into the trough including a pipe supplying water to the feeder;

at least one nipple in the feeder actuable by the animals for control by the animals of the dispensing of the water into the trough arranged such that said at least one nipple avoids dispensing water onto the shelf;

the pipe including a hose through which the water passes prior to reaching said at least one nipple where the hose has a diameter less than the pipe and less than 0.5 inches.

According to a yet further aspect of the invention there is provided feeder for animals comprising:

an elongate trough having a base and a sidewall for receiving and containing feed and water and arranged such that the head of the animal can reach over an upper front edge of the sidewall to the base for eating the feed and water;

an elongate shelf providing a substantially horizontal surface for receiving feed;

the horizontal surface of said shelf being arranged at a height above and rearwardly of said front edge so as to allow access by the head of the animal to said shelf for direct feeding therefrom, and between said shelf and said front edge to the base;

a hopper for continually depositing feed onto said shelf arranged such that deposited feed on the shelf remains on said shelf but can be removed to the trough by the animal;

a water supply for the feeder for dispensing water into the trough including a pipe supplying water to the feeder;

the pipe including a water supply line in the feeder extending longitudinally of the trough and including a plurality of nipples in the feeder at spaced positions along the water supply line each actuable by the animals for control by the animals of the dispensing of the water into the trough, with the nipples arranged such that each avoids dispensing water onto the shelf;

the pipe including a restriction hose located within the pipe through which the water passes;

the hose having a coupling at one end holding the hose at a fixed position within the pipe and causing the water in the pipe to pass through the hose prior to reaching the nipples.

Preferably an opposed end of the hose is free to float within the pipe.

Preferably the coupling is located at an end connector of a first pipe portion of the pipe where the first pipe portion is connected to a second pipe portion.

Preferably the coupling of the hose is attached to the hose as a press fit.

Preferably the coupling of the hose includes a collar which has an outside edge engaging an inner surface of the pipe to hold the coupling at a fixed position within the pipe.

The long-standing problem herein by which the animals can over feed the water into the trough by repeated or extended operation of the water supply nipples is solved in a manner which is totally surprising. This is done without additional controls to actually measure the amount of water in the trough, which only partly solves the problem since even that amount of water allowed up to the measure level is not desirable. The solution which reduces the flow rate by passing the water though a narrow hose is surprising in that reducing the low rate does not in fact limit the maximum water which can be introduced into the trough should the animals act to run the nipples sufficiently long to supply excess water. However it has been found that the reduced rate of supply of water in practice causes the animals themselves to limit the amount supplied into the trough.

### BRIEF DESCRIPTION OF THE DRAWINGS

Embodiments of the invention will now be described in conjunction with the accompanying drawings in which:

FIG. 1 is an isometric view of an embodiment of feeder according to the present invention.

FIG. 2 is an isometric view of the water line of the feeder of FIG. 1.

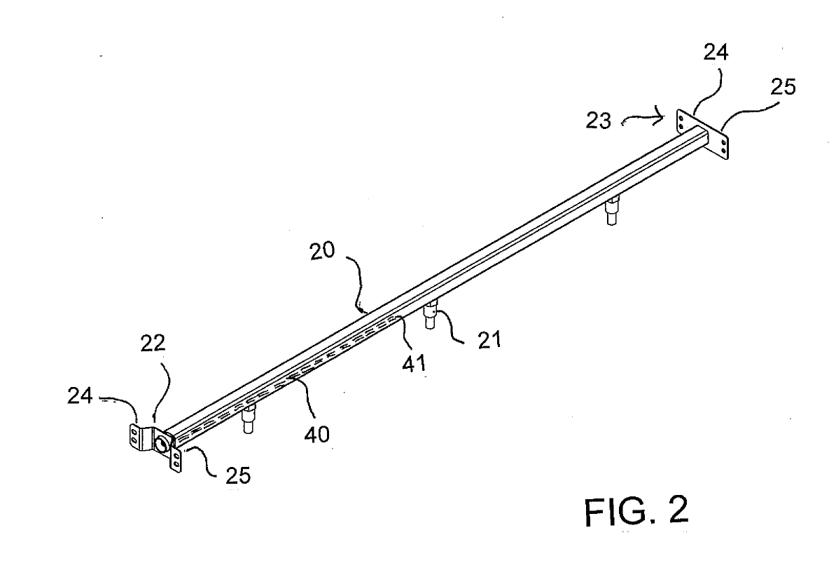

FIG. 3 is an isometric view of the end of the water line of FIG. 2 showing the fitting which locates the small diameter flexible in the water supply line.

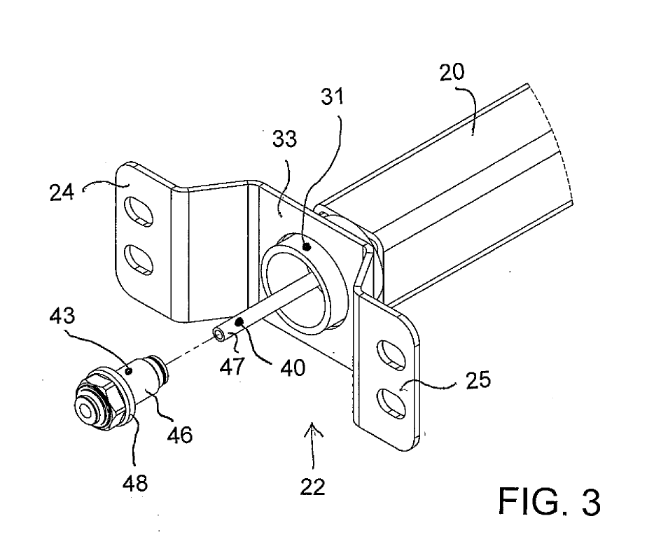

FIG. 4 is a cross-sectional view of the end of the water line of FIG. 2 showing the fitting which locates the small diameter flexible in the water supply line.

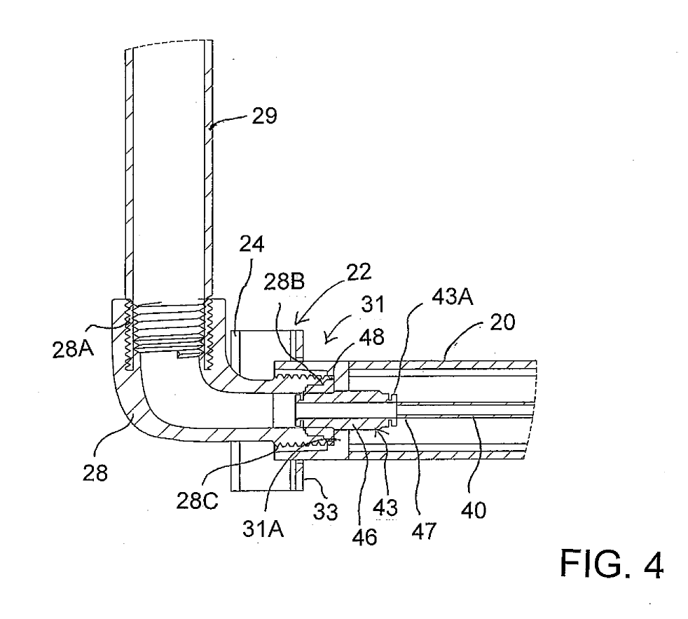

### DETAILED DESCRIPTION

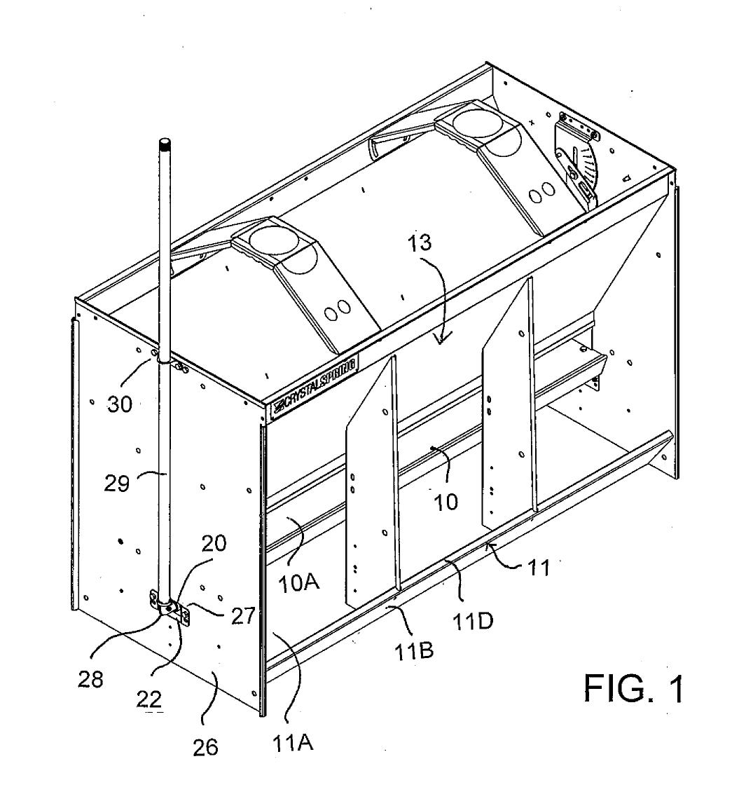

The embodiment shown in FIG. 1 is of the type shown a wet and dry feeder or shelf-type feeder in which the feed is deposited onto a shelf 10 positioned above a trough 11 so that the feed is available in dry condition on the shelf 10 accessible by the animal and can be moved by the animal to the trough for mixing with water for taking in wet condition. A hopper 13 is located above the shelf for depositing the feed on the shelf. This type of feeder is well known and further details are shown in the above three patents of the present inventor, the disclosures of which are incorporated herein by reference.

The feeder can be double sided or single sided as is well known. The feeder can be adjustable as described in the second and third above patents or may be a fixed size feeder as disclosed in the first above patent.

Beneath the shelf is a first water line 20 with a series of animal controlled nipples 21 at spaced positions along the length of the water line which can be actuated by the animal to discharge water into the trough from the first water line. The nipples can be bite nipples which are not intended to drink from but discharge into the trough or they may be drinking nipples. When actuated water runs freely from the supply line 20 into the trough 11.

The water supply line 20 comprises an elongate tubular duct of square cross-section with the nipples attached onto a bottom face of the square tube. At each end of the tube is provided a respective bracket 22, 23 in the form of a plate with two side wings 24, 25 which bolt to a respective end wall 26 of the feeder.

As shown in previous examples of the feeder of the present Applicants, the end walls 26 are parallel and sand vertically so as to form ends of the hopper 13 and the trough 11. Each end wall has a hole 27 through which the end of the water line projects to allow the attachment of the bracket to the exterior of the end wall.

Water is supplied to the water line by a pipe 29 connected at the bracket 22 to the line 20 by an elbow 28 connected by a thread 28A. The pipe 29 extends vertically to an over had connector of a water supply (not shown). The pipe is held vertical by a bracket 30 at the top of the wall 26 and by the bracket 22.

The water line 20 is connected to the bracket 22 by a fitting 31 which also connects to the elbow 28. The fitting 31 is of circular cross-section and inserts into an end of the square tube forming the water line.

The bracket 22 has a center web 33 to which the fitting 31 is attached with the web 33 parallel to and recessed from the wings 24, 25 so that the fitting 31 is protected in the recessed center section of the bracket to prevent damage by impact.

The arrangement herein therefore provides an apparatus and method of feeding animals where the feeder includes the elongate trough 11 having a base 11A and a sidewall 11B for receiving and containing feed and water and arranged such that the head of the animal can reach over an upper front edge 110 of the sidewall 11B to the base 11A for eating the feed and water.

The horizontal surface 10A of said shelf being arranged at a height above and rearwardly of the front edge so as to allow access by the head of the animal to the shelf for direct feeding therefrom, and between the shelf and the front edge to the base.

The hopper is arranged for continually depositing feed onto the shelf arranged such that deposited feed on the shelf remains on said shelf but can be removed to the trough by the animal.

The water supply is managed and controlled by reducing a flow rate of water through the pipe by providing in the water supply a hose 40 through which the water passes prior to reaching said at least one nipple. The hose is selected to have a diameter less than the pipe 20 and less than 0.5 inches and preferably less than 0.25 inch. In one particular example which has been found to operate effectively, the hose has a diameter of the order of 5/32 inch.

The hose 40 is flexible and is located freely within the pipe 20 and arranged such that water flowing to the nipples is arranged to pass through the hose to restrict the flow of water passing through the pipe. The hose is mounted in place in the water line 20 by its attachment at one end to a coupling 43 arranged to be located within the pipe at the fitting 31 to hold the coupling 43 at fixed position within the pipe and to cause all water in the pipe to pass through the hose. The hose extends from the fitting 43 freely within the interior of the water line 20 and extends to an opposed end 41 of the hose is free to float within the pipe. The fitting 43 is located at the elbow 28 connecting the first pipe portion 29 of the pipe to the second pipe portion defining the water line 20.

The fitting 43 of the hose is attached to the hose 40 as a press fit 43A by insertion of the end 47 of the hose into a sleeve 46. The fitting includes a collar 48 which has an outside edge engaging an inner surface of the fitting 31 of the pipe with the collar clamped between an end face 31A of the fitting 31 and an end face 28B of the elbow 28 at a connected threaded section 28C thereof to hold the coupling at a fixed position within the pipe.

Thus the hose is a simple insert fit into the pipe 20 during the assembly of the pipe 20 and the supply pipe 29 at the elbow 28 and sits within the pipe 20 to the free end 41. The length of the hose is sufficient to restrict the flow rate so that the water flows slowly into the trough and this has been found to slow the flow into the trough sufficiently that the animals, even though they may play with the nipple do not play sufficiently over a sufficient period to flow an excess mount of water into the trough.

1. A method of feeding animals comprising:
providing for the animals access to a feeder;
providing in the feeder an elongate trough having a base and a sidewall for receiving and containing feed and water and arranged such that the head of the animal can reach over an upper front edge of the sidewall to the base for eating the feed and water;
providing in the feeder an elongate shelf providing a substantially horizontal surface for receiving feed;
the horizontal surface of said shelf being arranged at a height above and rearwardly of said front edge so as to allow access by the head of the animal to said shelf for direct feeding therefrom, and between said shelf and said front edge to the base;
providing in the feeder a hopper for continually depositing feed onto said shelf arranged such that deposited feed on the shelf remains on said shelf but can be removed to the trough by the animal;
providing a water supply for the feeder for dispensing water into the trough including a pipe supplying water to the feeder;
and managing the water supply to the trough by:
providing at least one nipple in the feeder actuable by the animals for control by the animals of the dispensing of the water into the trough arranged such that said at least one nipple avoids dispensing water onto the shelf;
and reducing a flow rate of water through the pipe by providing in the water supply a hose through which the water passes prior to reaching said at least one nipple where the hose has a diameter less than the pipe and less than 0.5 inches.

2. The method according to claim 1 wherein the hose has a diameter less than 0.25 inch.

3. The method according to claim 1 wherein the hose has a diameter of the order of 5/32 inch.

4. The method according to claim 1 wherein the hose is flexible.

5. The method according to claim 1 wherein the hose is located within the pipe and arranged such that water flowing to said at least one nipple is arranged to pass through the hose to restrict the flow of water passing through the pipe.

6. The method according to claim 1 wherein the hose is attached at one end to a coupling arranged to be located within the pipe to hold the coupling at fixed position within the pipe and to cause all water in the pipe to pass through the hose.

7. The method according to claim 6 wherein an opposed end of the hose is free to float within the pipe.

8. The method according to claim 6 wherein the coupling is located at an end connector of a first pipe portion of the pipe where the first pipe portion is connected to a second pipe portion.

9. The method according to claim 8 wherein the first pipe portion containing the hose is located in the trough and to which said at least one nipple is connected.

10. The method according to claim 6 wherein the coupling of the hose is attached to the hose as a press fit.

11. The method according to claim 10 wherein the coupling of the hose includes a collar which has an outside edge engaging an inner surface of the pipe to hold the coupling at a fixed position within the pipe.

12. The method according to claim 1 wherein the at least one nipple of the second water supply line is arranged beneath the shelf and arranged to direct water downwardly therefrom into the trough.

13. The method according to claim 1 wherein said at least one nipple is arranged such that the animal is not intended to drink directly from it.

14. The method according to claim 1 wherein there is provided a row of nipples along a water line of the pipe within the feeder so as to discharge water from the hose into the trough.

15. A feeder for animals comprising:
an elongate trough having a base and a sidewall for receiving and containing feed and water and arranged such that the head of the animal can reach over an upper front edge of the sidewall to the base for eating the feed and water;
an elongate shelf providing a substantially horizontal surface for receiving feed;
the horizontal surface of said shelf being arranged at a height above and rearwardly of said front edge so as to allow access by the head of the animal to said shelf for direct feeding therefrom, and between said shelf and said front edge to the base;
a hopper for continually depositing feed onto said shelf arranged such that deposited feed on the shelf remains on said shelf but can be removed to the trough by the animal;
a water supply for the feeder for dispensing water into the trough including a pipe supplying water to the feeder;
at least one nipple in the feeder actuable by the animals for control by the animals of the dispensing of the water into the trough arranged such that said at least one nipple avoids dispensing water onto the shelf;
the pipe including a hose through which the water passes prior to reaching said at least one nipple where the hose has a diameter less than the pipe and less than 0.5 inches.

16. A feeder for animals comprising:
an elongate trough having a base and a sidewall for receiving and containing feed and water and arranged such that the head of the animal can reach over an upper front edge of the sidewall to the base for eating the feed and water;
an elongate shelf providing a substantially horizontal surface for receiving feed;
the horizontal surface of said shelf being arranged at a height above and rearwardly of said front edge so as to allow access by the head of the animal to said shelf for direct feeding therefrom, and between said shelf and said front edge to the base;
a hopper for continually depositing feed onto said shelf arranged such that deposited feed on the shelf remains on said shelf but can be removed to the trough by the animal;
a water supply for the feeder for dispensing water into the trough including a pipe supplying water to the feeder;
the pipe including a water supply line in the feeder extending longitudinally of the trough and including a plurality of nipples in the feeder at spaced positions along the water supply line each actuable by the animals for control by the animals of the dispensing of the water into the trough, with the nipples arranged such that each avoids dispensing water onto the shelf;
the pipe including a restriction hose located within the pipe through which the water passes;
the hose having a coupling at one end holding the hose at a fixed position within the pipe and causing the water in the pipe to pass through the hose prior to reaching the nipples.

17. The feeder according to claim 16 wherein an opposed end of the hose is free to float within the pipe.

18. The feeder according to claim 16 wherein the coupling is located at an end connector of a first pipe portion of the pipe where the first pipe portion is connected to a second pipe portion.

19. The feeder according to claim 16 wherein the coupling of the hose is attached to the hose as a press fit.

20. The feeder according to claim 19 wherein the coupling of the hose includes a collar which has an outside edge engaging an inner surface of the pipe to hold the coupling at a fixed position within the pipe.
